(19) United States
(12) Patent Application Publication
(10) Pub. No.: US 2013/0139975 A1
(43) Pub. Date: Jun. 6, 2013

(54) MOTOR CONTROL CIRCUIT AND KEYBOARD ASSEMBLY HAVING SAME

(71) Applicants: SONG-LIN TONG, Shenzhen City (CN); QI-YAN LUO, Shenzhen City (CN); HAI-QING ZHOU, Shenzhen City (CN)

(72) Inventors: SONG-LIN TONG, Shenzhen City (CN); QI-YAN LUO, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/563,755

(22) Filed: Aug. 1, 2012

(30) Foreign Application Priority Data
Dec. 2, 2011 (CN) 201110395126.X

(51) Int. Cl. H02P 1/22; E05F 15/20

(52) U.S. Cl. 160/2; 318/283

(57) ABSTRACT

A motor control circuit for controlling rotation directions of a motor includes a primary power supply, a voltage monitor unit, a motor driving chip, a controller and a backup power supply. The backup power supply is constantly charged by the primary power supply when the primary power supply is in service. The voltage monitor unit is electronically connected to the primary power supply, and is configured for determining whether the primary power supply is in or out of service. The controller controls the motor driving chip to drive the motor to rotate in a first direction when the primary power supply is in service, and alternatively controlling the motor driving chip to drive the motor to rotate in a second direction reverse to the first direction when the primary power supply is out of service.

### BACKGROUND

1. Technical Field

The exemplary disclosure generally relates to motor control circuits and keyboards; and particularly to a motor control circuit for controlling rotational direction of a motor, and a keyboard assembly having the motor control circuit.

2. Description of Related Art

Computer keyboards are usually exposed to environmental contaminants, and are easily polluted by dust or other particles. A dust-proof keyboard may include a spindle, a flexible lid scrolled about the spindle, a motor for driving the spindle to rotate, and a button electronically connected to the motor. When the button is pressed, the motor drives the spindle to rotate to lay the flexible lid on the keyboard, whereby the flexible lid covers the keyboard to prevent the keyboard from being contaminated.

However, because the motor is controlled by the button, if a user forgets to press the button after using the keyboard, the keyboard is not covered by the flexible lid.

Therefore, there is room for improvement within the art.

### BRIEF DESCRIPTION OF THE DRAWINGS

Many aspects of the embodiments can be better understood with reference to the drawings. In the drawings, the emphasis is placed upon clearly illustrating the principles of the disclosure.

FIG. 1 is a block diagram of a keyboard assembly according to an exemplary embodiment, the keyboard assembly including a motor control circuit and a motor.

FIG. 2 is essentially a circuit diagram of the motor control circuit and motor shown in FIG. 1.

FIG. 3 is a circuit diagram of a charging unit, a primary power supply and a backup power supply of the motor control circuit shown in FIG. 1.

### DETAILED DESCRIPTION

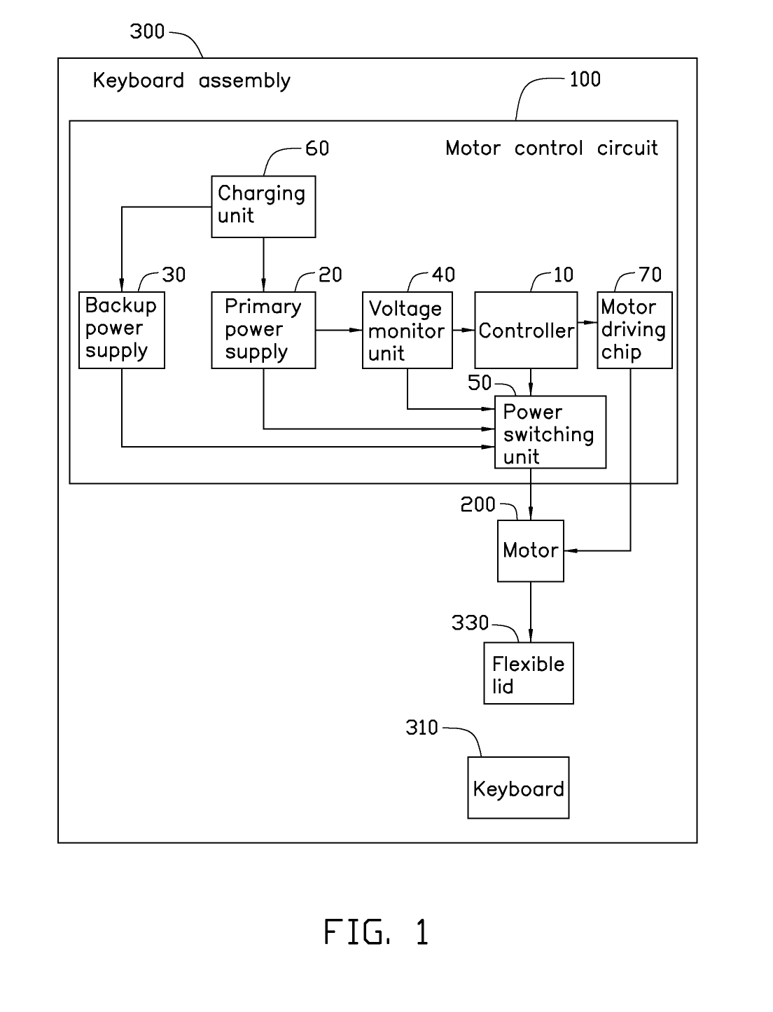

FIG. 1 is a block diagram of a keyboard assembly having a motor control circuit, according to an exemplary embodiment. The keyboard assembly 300 can be used in conjunction with a computer for example. The keyboard assembly 300 includes the motor control circuit 100, a motor 200, a keyboard 310, and a flexible lid 330 driven by the motor 200. The keyboard 310 has a plurality of keys arranged thereon. The motor control circuit 100 can control the motor 200 to rotate clockwise or counterclockwise. The flexible lid 330 is withdrawn to expose the keyboard 310 when the motor 200 rotates in a first direction, e.g. in the clockwise direction, under the control of the motor control circuit 100. The flexible lid 330 is moved to cover a top surface of the keyboard 310 when the motor 200 rotates in a second direction reverse to the first direction, e.g. in the counterclockwise direction, under the control of the motor control circuit 100. In the exemplary embodiment, the motor 200 is an electro-mechanical servo motor.

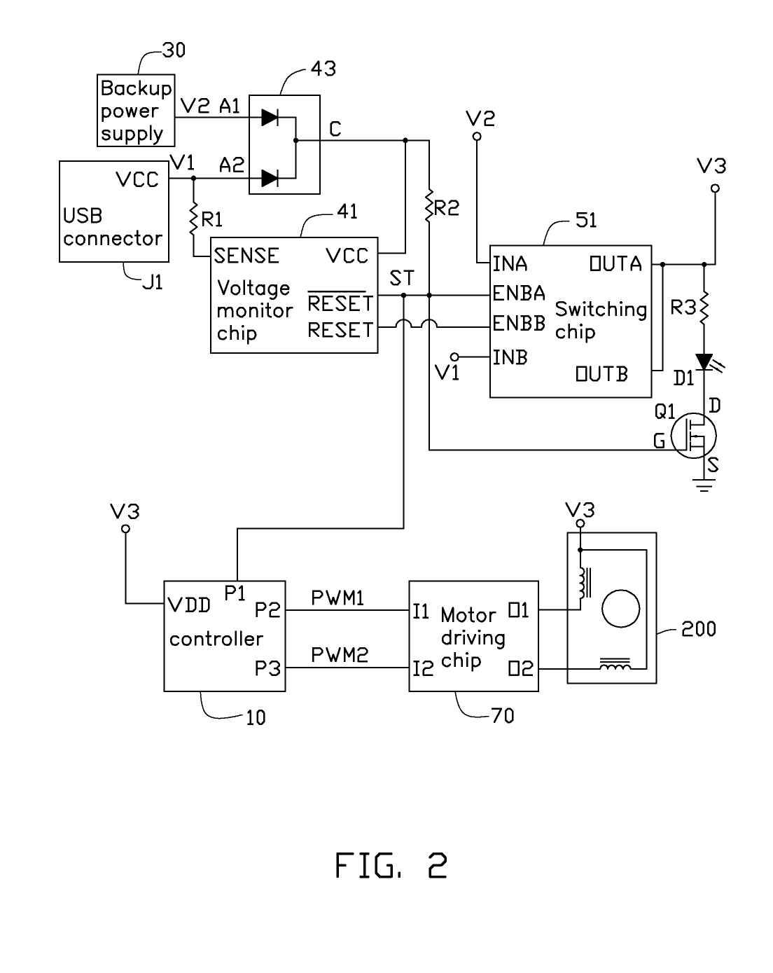

The motor control circuit 100 according to an exemplary embodiment includes a controller 10, a primary power supply 20, a backup power supply 30, a voltage monitor unit 40, a power switching unit 50, a charging unit 60, and a motor driving chip 70. The voltage monitor unit 40 determines a working state of the primary power supply 20 according to an output voltage V1 (shown in FIG. 2) of the primary power supply 20, and outputs a state signal ST (shown in FIG. 2). The controller 10 controls the motor to rotate clockwise or counterclockwise according to the state signal ST. The primary power supply 20 constantly charges the backup power supply 30 via the charging unit 60 when the primary power supply 20 is in service. The power switching unit 50 switches on the backup power supply 30 to power the controller 10 and the motor 200 as a substitute for the primary power supply 20 when the output voltage V1 of the primary power supply 20 is lower than a predetermined threshold voltage.

FIG. 2 is a circuit diagram of the motor control circuit 100 and motor 200. The controller 10 has a state signal input pin P1, a first controlling pin P2, a second controlling pin P3, and a power pin VDD. The state signal input pin P1 receives the state signal ST outputted from the voltage monitor unit 40. Both of the first and second controlling pins P2 and P3 are electronically connected to the motor driving chip 70, to transmit a first controlling signal PWM1 and a second controlling signal PWM2 respectively to the motor driving chip 70. In one embodiment, the first and second controlling signals PWM1, PWM2 are in antiphase.

In the exemplary embodiment, the output voltage V1 of the primary power supply 20 is supplied by a power supply unit of a computer through a power supply pin VCC of a Universal Serial Bus (USB) connector J1 of the keyboard 310. Hence the primary power supply 20 seen in FIG. 1 is shown as the USB connector J1 in FIG. 2. The USB connector J1 is connected to another USB connector (not shown) of the computer. When the computer is powered on, the output voltage V1 is +5 volts; and when the computer is powered off, the output voltage V1 decreases gradually to 0 volts.

The backup power supply 30 is preferably a rechargeable battery pack, such as a supercapacitor or a nickel-hydrogen battery. In the exemplary embodiment, the backup power supply 30 is a supercapacitor which has a rated output voltage labeled as V2 in FIG. 2.

The voltage monitor unit 40 includes a voltage monitor chip 41 and a Schottky diode 43. The voltage monitor chip 41 has a voltage input pin VCC, a detecting pin SENSE, a first output pin R̅E̅S̅E̅T̅, and a second output pin RESET. The voltage input pin VCC is electronically connectable to either the primary power supply 20 or the backup power supply 30. In the exemplary embodiment, the voltage input pin VCC is electronically connected to the primary power supply 20 and to the backup power supply 30 via the Schottky diode 43. The detecting pin SENSE is electronically connected to the primary power supply 20 via a first current limiting resistor R1. The first output pin R̅E̅S̅E̅T̅ is electronically connected to the Schottky diode 43 via a pull-up resistor R2, and is electronically connected to the state signal input pin P1 of the controller 10. The first output pin R̅E̅S̅E̅T̅ is configured for outputting the state signal ST arising from a comparison between the output voltage V1 and the predetermined threshold voltage stored in the voltage monitor chip 41. When the output voltage V1 of the primary power supply 20 is higher than the predetermined threshold voltage, the first output pin R̅E̅S̅E̅T̅ outputs the state signal ST as a high level signal (e.g. logic 1), and the second output pin RESET outputs a low level signal (e.g. logic 0). When the computer is powered off, the output voltage V1 of the primary power supply 20 decreases gradually until it is lower than the predetermined threshold voltage, then the first output pin R̅E̅S̅E̅T̅ outputs a low level signal as the state signal ST, and the second output pin RESET outputs a high level signal.

In one embodiment, the value of the predetermined threshold voltage is 4.25V, and the voltage monitor chip 41 is a TL7733BIDR type made by Texas Instruments (TI). The Schottky diode 43 is a BAT54C type made by STMicroelectronics (ST). The Schottky diode 43 has two input terminals, A1 and A2, and an output terminal C. The input terminals A1 and A2 are electronically connected to the primary power supply 20 and to the backup power supply 30 respectively. The output terminal C is electronically connected to the voltage input pin VCC, and is also electronically connected to the first output pin R̅E̅S̅E̅T̅ via the pull-up resistor R2. The primary power supply 20 powers the voltage monitor chip 41 via the Schottky diode 43 when the computer is working, and the backup power supply 30 powers the voltage monitor chip 41 via the Schottky diode 43 after the computer has been shut down.

The power switching unit 50 includes a switching chip 51, a light emitting diode (LED) D1, an N-channel metal-oxide-semiconductor field-effect transistor (MOSFET) Q1, and a second current limiting resistor R3. The switching chip 51 has a first power input pin INA electronically connected to the backup power supply 30, a second power input pin INB electronically connected to the primary power supply 20, a first enable pin ENBA electronically connected to the first output pin R̅E̅S̅E̅T̅, a second enable pin ENBB, a first power output pin OUTA, and a second power output pin OUTB electronically connected to the first power output pin OUTA. A node between the first and second power output pins OUTA and OUTB is electronically connected to the motor 200 and the power pin VDD of the controller 10, and the node outputs a power voltage labeled as V3 in FIG. 2 to the motor 200 and the power pin VDD of the controller 10.

The first enable pin ENBA is configured for controlling an electronic connection between the first power input pin INA and the first power output pin OUTA. When the first enable pin ENBA is activated by the voltage monitor chip 41, that is, when the voltage monitor chip 41 outputs a low level signal as the state signal ST to the first enable pin ENBA via the first output pin R̅E̅S̅E̅T̅, the first power input pin INA is electronically connected to the first power output pin OUTA to construct a current path. The second enable pin ENBB is configured for controlling an electronic connection between the second power input pin INB and the second power output pin OUTB, and is activated by a low level signal.

An anode of the LED D1 is electronically connected to the node between the first and second power output pins OUTA and OUTB via the second current limiting resistor R3, and a cathode of the LED D1 is electronically connected to a drain D of the N-channel MOSFET Q1. A source S of the N-channel MOSFET Q1 is grounded, and a gate G of the N-channel MOSFET Q1 is electronically connected to the first output pin R̅E̅S̅E̅T̅.

When the computer is working, the primary power supply 20 is in service, and the first and second output pins R̅E̅S̅E̅T̅ and RESET of the voltage monitor chip 41 output a high level signal and a low level signal respectively. The second enable pin ENBB is activated, and thus the primary power supply 20 is able to power the controller 10 and the motor 200. In addition, the N-channel MOSFET Q1 is turned on, and thus the LED D1 is illuminated. When the computer is shut down, the primary power supply 20 goes out of service, and the output voltage V1 decreases to the predetermined threshold voltage. Thereupon the first and second output pins R̅E̅S̅E̅T̅ and RESET of the voltage monitor chip 41 output a low level signal and a high level signal respectively, so the first enable pin ENBA is activated and thus the backup power supply 30 is able to power the controller 10 and the motor 200. Further, the N-channel MOSFET Q1 is turned off, and the LED D1 is also turned off.

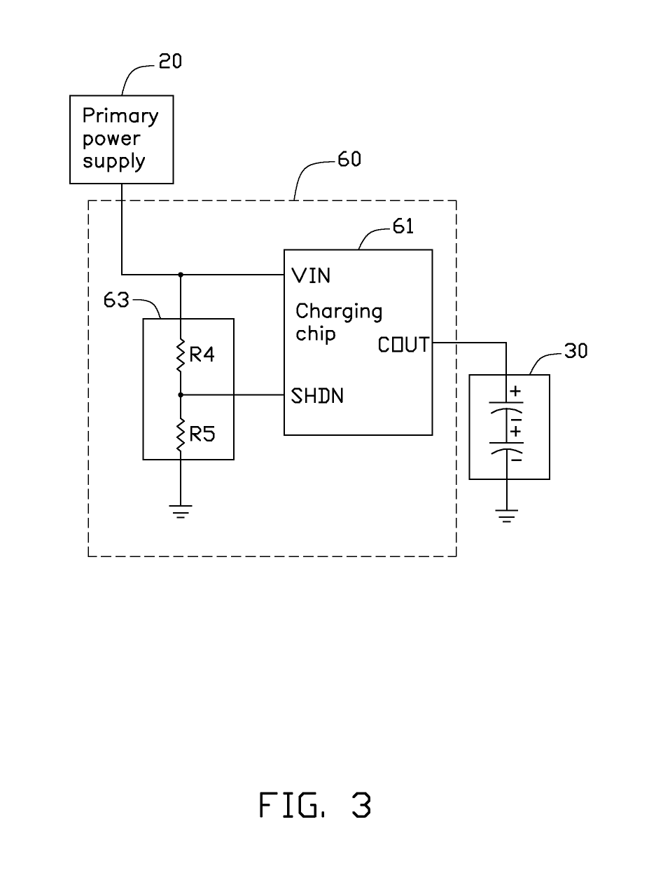

FIG. 3 is a circuit diagram of the charging unit 60, the primary power supply 20 and the backup power supply 30 of the motor control circuit 100. The charging unit 60 includes a charging chip 61 and a voltage dividing circuit 63. The charging chip 61 has a power input pin VIN electronically connected to the primary power supply 20, a charging pin COUT electronically connected to the backup power supply 30, and an enable pin SHDN. The voltage dividing circuit 63 includes a first voltage dividing resistor R4 and a second voltage dividing resistor R5, which are connected in series between the primary power supply 20 and ground. The enable pin SHDN is electronically connected to a node between the first and second voltage dividing resistors R1 and R2. The enable pin SHDN is activated when the primary power supply 20 is in service, during which time the charging chip 61 converts a source current of the primary power supply 20 into a charging current, which is then forwarded to the backup power supply 30 (e.g. a supercapacitor).

Referring again to FIG. 2, the motor driving chip 70 has a first signal input terminal I1 electronically connected to the first controlling pin P2, a second signal input terminal I2 electronically connected to the second controlling pin P3, a first signal output terminal O1 corresponding to the first signal input terminal I1, and a second signal output terminal O2 corresponding to the second signal input terminal I2. Both of the first and second signal output terminals O1 and O2 are electronically connected to the motor 200. When the primary power supply 20 is in service, the state signal ST outputted from the voltage monitor chip 41 is a high level signal, the first controlling signal PWM1 outputted from the controller 10 to the motor driving chip 70 is a first level signal (such as a high level signal), and the second controlling signal PWM2 outputted from the controller 10 to the motor driving chip 70 is a second level signal (such as a low level signal), and this signaling arrangement causes the motor driving chip 70 to drive the motor 200 clockwise. Alternatively, when the primary power supply 20 goes out of service, the output voltage V1 becomes lower than the predetermined threshold voltage. Accordingly, the state signal ST outputted from the voltage monitor chip 41 is a low level signal, the first controlling signal PWM1 outputted from the controller 10 to the motor driving chip 70 is the second level signal (a low level signal), and the second controlling signal PWM2 outputted from the controller 10 to the motor driving chip 70 is the first level signal (a high level signal). This signaling arrangement causes the motor driving chip 70 to drive the motor 200 counterclockwise.

In typical use of the keyboard assembly 300, the keyboard 310 is electronically connected to a computer via the USB connector J1. When the computer is working, the voltage output from the power pin VCC of the USB connector J1 is 5 volts, that is, the primary power supply 20 is in service. The charging unit 60 charges the backup power supply 20. Simultaneously, the first output pin R̅E̅S̅E̅T̅ of the voltage monitor chip 41 outputs a high level signal, the power switching unit 50 connects the primary power supply 20 to the controller 10 and the motor 200, and the controller 10 causes the motor driving chip 70 to drive the motor 200 clockwise, to cause the flexible lid 330 to withdraw or to be kept withdrawn so as to expose the keyboard 310. When the computer is shut down, the voltage of the power pin VCC of the USB connector J1 decreases gradually, that is, the output voltage V1 of the primary power supply 20 decreases gradually. When the output voltage V1 is lower than the predetermined threshold voltage, the first output pin R̅E̅S̅E̅T̅ of the voltage monitor chip 41 outputs a low level signal, the power switching unit 50 connects the backup power supply 30 to the controller 10 and the motor 200, and the controller 10 causes the motor driving chip 70 to drive the motor 200 counterclockwise, to pull and extend the flexible lid 330 over the keyboard 310 to protect it.

The voltage monitor unit 40 detects the working state of the primary power supply 20, and outputs a state signal ST to the controller 10. The controller 10 controls the motor driving chip 70 to drive the motor 200 clockwise when the primary power supply 20 is in service, thereby driving the flexible lid 330 to be withdrawn to expose the keyboard 310. When the primary power supply 20 is out of service, the controller 10 controls the motor driving chip 70 to drive the motor 200 counterclockwise, thereby pulling and extending the flexible lid 330 to cover the keyboard 310. The motor control circuit 100 can control the rotation direction of the motor 200 according to the working state of the computer, so that when the computer is shut down the flexible lid 330 is automatically drawn across the keyboard 310.

The exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A motor control circuit for controlling rotation directions of a motor, comprising:
a primary power supply;
a backup power supply charged by the primary power supply when the primary power supply is in service;
a voltage monitor unit electronically connected to the primary power supply, and configured for determining whether the primary power supply is in or out of service;
a motor driving chip electronically connected to the motor; and
a controller controlling the motor to obtain power supply from the primary power supply and the motor driving chip to drive the motor to rotate in a first direction when the primary power supply is in service, and alternatively controlling the motor to obtain power supply from the backup power supply and the motor driving chip to drive the motor to rotate in a second direction reverse to the first direction when the primary power supply is out of service.

2. The motor control circuit of claim 1, wherein the voltage monitor unit comprises a voltage monitor chip, which comprises a voltage input pin, a detecting pin electronically connected to the primary power supply, and a first output pin, the voltage input pin is electronically connectable to either the primary power supply or the backup power supply according to the working state of the primary power supply, and the first output pin is electronically connected to the controller.

3. The motor control circuit of claim 2, wherein the first output pin outputs a high level signal when the output voltage of the primary power supply is higher than a predetermined threshold voltage detected by the detecting pin, and the first output pin outputs a low level signal when the output voltage of the primary power supply is lower than the predetermined threshold voltage.

4. The motor control circuit of claim 2, wherein the voltage motor chip further comprises a Schottky diode, which comprises two input terminals and an output terminal, the two input terminals are electronically connected to the primary power supply and to the backup power supply respectively, and the output terminal is electronically connected to the power input pin of the voltage monitor chip.

5. The motor control circuit of claim 2, wherein the voltage monitor chip further comprises a second output pin, the voltage level of the second output pin is opposite to the voltage level of the first output pin; the motor control circuit further comprises a power switching unit having a switching chip, the switching chip has a first power input pin electronically connected to the backup power supply, a second power input pin electronically connected to the primary power supply, a first enable pin electronically connected to the first output pin of the voltage monitor chip, a second enable pin electronically connected to the second output pin of the voltage monitor chip, a first power output pin, and a second power output pin electronically connected to the first power output pin; a node between the first and second power output pins is electronically connected to both the controller and the motor; and the first enable pin is configured for controlling the electronic connection between the first power input pin and the first power output pin, and the second enable pin is configured for controlling the electronic connection between the second power input pin and the second power output pin.

6. The motor control circuit of claim 5, wherein the power switching unit further comprises a light emitting diode (LED) and an N-channel metal-oxide-semiconductor field-effect transistor (MOSFET), an anode of the LED is electronically connected to the node between the first and second power output pins, a cathode of the LED is electronically connected to a drain of the N-channel MOSFET, a source of the N-channel MOSFET is grounded, and a gate of the N-channel MOSFET is electronically connected to the first output pin.

7. The motor control circuit of claim 1, further comprising a charging unit for charging the backup power supply, wherein the charging unit comprises a charging chip having a third enable pin, a power input pin electronically connected to the primary power supply, and a charging pin electronically connected to the backup power supply, the enable pin is activated when the primary power supply is in service, and the charging chip converts a source current of the primary power supply to a charging current to charge the backup power supply.

8. The motor control circuit of claim 1, wherein the charging unit further comprises a first voltage dividing resistor and a second voltage dividing resistor, and the first and second voltage dividing resistors are electronically connected in series between the primary power supply and ground.

9. The motor control circuit of claim 1, wherein the output voltage of the primary power supply is supplied by a power unit of a computer through a power supply pin of a Universal Serial Bus (USB) connector, the primary power supply is in service when the computer is working, and the primary power supply is out of service when the computer is shut down.

10. The motor control circuit of claim 1, wherein the backup power supply is one of a supercapacitor and a nickel-hydrogen battery.

11. A keyboard assembly, comprising:
a keyboard;
a flexible lid mounted to the keyboard;
a motor configured for driving the flexible lid to be withdrawn or be extended; and
a motor control circuit configured for controlling rotation directions of the motor, comprising:
a primary power supply;
a backup power supply constantly charged by the primary power supply when the primary power supply is in service;
a voltage monitor unit electronically connected to the primary power supply, and configured for determining whether the primary power supply is in or out of service;
a motor driving chip electronically connected to the motor; and
a controller controlling the motor to obtain power supply from the primary power supply and the motor driving chip to drive the motor to rotate in a first direction when the primary power supply is in service, and controlling the motor to obtain power supply from the backup power supply and the motor driving chip to drive the motor to rotate in a second direction reverse to the first direction when the primary power supply is out of service;
wherein the flexible lid is withdrawn to expose the keyboard when the motor rotates in the first direction, and the flexible lid is extended to cover the keyboard when the motor rotates in the second direction.

12. The keyboard assembly of claim 11, wherein the voltage monitor unit comprises a voltage monitor chip, which comprises a voltage input pin, a detecting pin electronically connected to the primary power supply, and a first output pin, the voltage input pin is electronically connectable to either the primary power supply or the backup power supply according to the working state of the primary power supply, and the first output pin is electronically connected to the controller.

13. The keyboard assembly of claim 12, wherein the first output pin outputs a high level signal when the output voltage of the primary power supply is higher than a predetermined threshold voltage detected by the detecting pin, and the first output pin outputs a low level signal when the output voltage of the primary power supply is lower than the predetermined threshold voltage.

14. The keyboard assembly of claim 12, wherein the voltage motor chip further comprises a Schottky diode, which comprises two input terminals and an output terminal, the two input terminals are electronically connected to the primary power supply and the backup power supply respectively, and the output terminal is electronically connected to the power input pin of the voltage monitor chip.

15. The keyboard assembly of claim 12, wherein the voltage monitor chip further comprises a second output pin, the voltage level of the second output pin is opposite to the voltage level of the first output pin; the motor control circuit further comprises a power switching unit which comprises a switching chip, the switching chip has a first power input pin electronically connected to the backup power supply, a second power input pin electronically connected to the primary power supply, a first enable pin electronically connected to the first output pin of the voltage monitor chip, a second enable pin electronically connected to the second output pin of the voltage monitor chip, a first power output pin, and a second power output pin electronically connected to the first power output pin; a node between the first and second power output pins is electronically connected to the controller and the motor; and the first enable pin is configured for controlling the electronic connection between the first power input pin and the first power output pin, and the second enable pin is configured for controlling the electronic connection between the second power input pin and the second power output pin.

16. The keyboard assembly of claim 15, wherein the power switching unit further comprises a light emitting diode (LED) and an N-channel metal-oxide-semiconductor field-effect transistor (MOSFET), an anode of the LED is electronically connected to the node between the first and second power output pins, a cathode of the LED is electronically connected to a drain of the N-channel MOSFET, a source of the N-channel MOSFET is grounded, and a gate of the N-channel MOSFET is electronically connected to the first output pin.

17. The keyboard assembly of claim 11, further comprising a charging unit for charging the backup power supply, wherein the charging unit comprises a charging chip having a third enable pin, a power input pin electronically connected to the primary power supply, and a charging pin electronically connected to the backup power supply, the enable pin is activated when the primary power supply is in service, and the charging chip converts a source current of the primary power supply to a charging current to charge the backup power supply.

18. The keyboard assembly of claim 11, wherein the charging unit further comprises a first voltage dividing resistor and a second voltage dividing resistor, and the first and second voltage dividing resistors are electronically connected in series between the primary power supply and ground.

19. The keyboard assembly of claim 11, wherein the output voltage of the primary power supply is supplied by a power unit of a computer through a power supply pin of a USB connector, the primary power supply is in service when the computer is working, and the primary power supply is out of service when the computer is shut down.

20. The keyboard assembly of claim 11, wherein the backup power supply is one of a supercapacitor and a nickel-hydrogen battery.
